(19) United States
(12) Patent Application Publication
(10) Pub. No.: US 2015/0045190 A1
(43) Pub. Date: Feb. 12, 2015

(54) ECCENTRIC IDLER

(71) Applicant: Keiser Corporation, Fresno, CA (US)

(72) Inventor: Dennis L. Keiser, Sanger, CA (US)

(21) Appl. No.: 14/385,127

(22) PCT Filed: Mar. 12, 2013
(86) PCT No.: PCT/US2013/030440

§ 371 Date: Sep. 12, 2014

Related U.S. Application Data
(60) Provisional application No. 61/610,971, filed on Mar. 14, 2012.

(51) Int. Cl. A63B 22/06; F16H 7/12; F16H 7/02

(52) U.S. Cl. CPC A63B 22/0605; F16H 7/02; F16H 7/1281
USPC 482/57; 474/112

(57) ABSTRACT

An eccentric idler is disclosed. One application of the eccentric idler is on a stationary exercise cycle. The cycle may include an eccentric driver or driven shaft rotating a belt or chain. The idler is coupled to the cycle and is configured to rotate eccentrically in contact with the belt or chain. The stationary exercise cycle of various embodiments is configured to generate reciprocating motion, thereby providing users with a vibratory exercise experience.

### CROSS-REFERENCE TO RELATED APPLICATIONS

This application claims priority under 35 U.S.C. §119(e) to U.S. Provisional Application No. 61/610,971, filed Mar. 14, 2012, entitled “ECCENTRIC IDLER,” which is hereby incorporated by reference in its entirety.

### BACKGROUND

1. Field of the Invention

The present invention relates generally to eccentric idler(s) for use with a drive system. The drive system includes an eccentric driver and/or driven shaft which drives a belt or chain. The eccentric idler contacts the driven belt or chain to maintain a generally constant length of the drive belt or chain. An exemplary application of the invention is for an exercise device such as a stationary exercise bicycle.

2. Description of the Related Art

The benefits of regular aerobic exercise have been well established. Regular aerobic exercise has been shown to enhance the fitness of individuals and may potentially increase their wellbeing and respective life spans. Stationary exercise bicycles provide a convenient means of performing aerobic exercise at home or in a gym or other fitness facility. Such devices are used to enhance the performance of serious athletes, as well as improve or maintain the fitness and health of individuals who partake in recreational exercise activity.

There are currently numerous stationary bicycles available in the marketplace. The main structure of conventional stationary bicycles includes a frame, a handlebar mounted at a front end of the frame, a display, a seat mounted at a rear end of the frame, a driving wheel, and a pair of pedals.

Engaging a wide range of muscle groups is often desirable during exercise; however, current models of stationary bicycles are configured to simulate the smooth pedaling movement of traditional bicycles, thereby working only a limited number of muscle groups, predominantly in the legs.

### SUMMARY

The systems and methods of the present invention have several features, no single one of which is solely responsible for its desirable attributes. Without limiting the scope, as expressed by the claims that follow, the more prominent features will be briefly discussed here. After considering this discussion, and particularly after reading the section entitled “Detailed Description of Certain Embodiments,” one will understand how the features of this invention provide several advantages of an eccentrically driven drive system.

One aspect in accordance with embodiments of the present invention is a cycle comprising a frame, an axle, a driving wheel, a flywheel, a belt, and an idler. The axle is disposed in the frame and configured to eccentrically rotate relative to the frame. The driving wheel is coupled to the axle. The flywheel is coupled to the frame so as to rotate about an axis, the axis being spaced from the axle along a line. The belt contacts the driving wheel and the flywheel. A first portion of the belt is disposed in a region above the line while a second portion of the belt is disposed in a region below the line. The idler is coupled to the frame and configured to rotate eccentrically with at least a portion of the idler contacting the belt so that the length of the belt in the first region and the length of the belt in the second region stay generally constant, at least when the belt drives the flywheel. In one embodiment, the driving wheel rotates eccentrically. The eccentric rotation of the axle imparts a vibration felt by a user of the cycle. This eccentric rotation of the axle is selectable by the user in some embodiments.

The frame comprises a bottom bracket having a central axis, wherein the axle rotates about an axis that is offset from the central axis. The position of the rotational axis of the axle relative to the frame changes as the axle rotates. In some embodiments, an eccentric sleeve is disposed between the bottom bracket and the axle. A bearing may be disposed between the eccentric sleeve and the bottom bracket. A center of the inside diameter of the eccentric sleeve is offset a distance from a center of the outside diameter of the eccentric sleeve. In some embodiments, the offset distance is 0.030 inch. This offset imparts a vibration felt by a user of the cycle.

Some embodiments include a cycle, as recited above, further comprising a second axle. The idler rotates about this second axle, and the portion of the idler contacting the belt rotates eccentrically relative to the axle. The idler has an eccentric outer circumference, and at least a portion of the belt contacts this eccentric outer circumference. In various embodiments, the idler comprises a clutch pulley, and the clutch pulley is driven by the flywheel. In some embodiments, the idler is configured to be driven by the flywheel.

In various embodiments, the axle is configured to receive one or more crank arms. The crank arms are configured to receive pedals, and a vibration induced by the eccentric rotation of the axle vibrates the pedals.

In some embodiments, the belt is a cable. In other embodiments, the belt is a chain. In various embodiments, the belt contacts a portion of an outer circumference of the driving wheel, and the distance between a contact point of the belt with the driving wheel at a fixed angular location and a rotational axis of the driving wheel changes as the axle is rotated.

Some embodiments include a cycle, as recited above, further comprising a second belt. The second belt contacts the flywheel and the eccentric idler. In some embodiments, the flywheel comprises a pulley, and the belt contacts this pulley.

In some embodiments, the cycle further comprises a second idler having an eccentric outer circumference. At least a portion of the eccentric outer circumference of the second idler contacts the belt. In various embodiments, the first and second idlers contact portions of the belt above and below the line, respectively. In some such embodiments, the second idler is configured to be driven by the first idler. The belt may be routed between the first and second idlers. The belt may additionally, or alternatively, be routed around at least the driving wheel and the flywheel.

The cycle may further comprise a toothed belt which contacts the first and second idlers. In some such embodiments, the axle comprises a pulley, and the toothed belt contacts the pulley. An angular orientation of the first idler relative to the second idler is maintained when the toothed belt rotates the first and second idlers.

In various embodiments of the cycle, the apparatus further comprises a gear shift and a handlebar assembly. The gear shift and handlebar assembly are adjustable for height by a user.

Another aspect in accordance with embodiments of the present invention is a cycle comprising a frame and a driving wheel configured to be rotated eccentrically by a user so as to impart a vibration felt by the user. The cycle further comprises a flywheel coupled to the frame, a belt contacting the driving wheel and the flywheel, and at least one idler fixed relative to the frame so as to rotate eccentrically. At least a portion of the idler contacts the belt. In various embodiments of the cycle, the eccentric rotation of the driving wheel is selectable by the user.

An additional aspect in accordance with embodiments of the present invention is an exercise apparatus comprising a frame, a driving wheel configured to be rotated eccentrically about a first axis so as impart a vibration, a flywheel coupled to the frame and configured to rotate about a second axis, a belt, and two idlers. The belt is routed between at least the driving wheel and the flywheel so that portions of the belt are disposed above and below an imaginary line running between the first and second axes. Additionally, each idler is fixed relative to the frame and configured to eccentrically rotate. One of the two idlers contacts the belt above the line and the other idler contacts the belt below the line.

An additional aspect in accordance with embodiments of the present invention is a drive system comprising a rotational member configured for eccentric rotation, a belt configured to rotate with the rotational member, and at least one idler contacting the belt and configured to rotate eccentrically so as to maintain a generally constant length of the belt.

### BRIEF DESCRIPTION OF THE DRAWINGS

These and other features, aspects, and advantages of the present invention will now be described in connection with preferred embodiments of the invention, in reference to the accompanying drawings. The illustrated embodiments, however, are merely examples and are not intended to limit the invention.

FIG. 1 is a left perspective view of an exercise apparatus in accordance with one embodiment of the present invention.

FIG. 2 is a right perspective view of the exercise apparatus of FIG. 1.

FIG. 3 is a right side view of the exercise apparatus of FIG. 1.

FIG. 4 is a left side view of one embodiment of a drive system for a stationary exercise bicycle.

FIG. 5 is a left perspective view of the drive system of FIG. 4.

FIG. 6A is a perspective view of one embodiment of a bottom bracket assembly from FIG. 4.

FIG. 6B is an exploded view of the bottom bracket assembly of FIG. 6A.

FIG. 6C is a side view of the bottom bracket assembly of FIG. 6A.

FIG. 7 is an exploded view of one embodiment of an idler assembly from FIG. 4.

FIGS. 8A and 8B are side views of the eccentric pulleys from FIG. 7.

### DETAILED DESCRIPTION OF CERTAIN EMBODIMENTS

Even though the invention is described in the context of an exercise device, the invention is not limited to exercise devices. The features of the invention may be employed in any drive system which relies upon eccentric motion to drive a belt or chain, but where it is desirable to isolate a portion of the drive system from the effects of the eccentric motion. For example, eccentric motion can undesirably cause localized stretching or increased tension on a belt or chain in a drive system leading to increased wear and possibly premature failure of the belt or chain. The inclusion of an eccentrically rotating idler into the drive system, as disclosed herein, isolates the eccentric motion from a portion of the drive system by maintaining a generally constant length of the belt or chain. For example, an exemplary drive system includes a driving wheel, a flywheel, and a belt rotationally coupling the flywheel to the driving wheel. It is desirable for the driving wheel to eccentrically rotate while the flywheel smoothly rotates. However, because the flywheel is rotationally coupled to the driving wheel, the eccentric rotation of the driving wheel causes undesirable fluctuations in the rotational speed of the flywheel or even slippage of the belt against the flywheel. To isolate the effects of the eccentric motion of the driving wheel from the flywheel and prevent slippage of the belt against the flywheel, one or more eccentric idlers contact the belt or chain at a location between the driving wheel and the flywheel. The eccentric idler(s) compensates for the effects of the eccentric motion of the driving wheel on the belt or chain by varying a travel distance of the belt or chain between the driving wheel and the flywheel. In this way the travel distance and the length of the belt or chain stays generally constant. The advantages provided by eccentric motion and its resulting vibration are maintained without causing localized stretching or increased tension on the belt or chain. For ease of explanation, the terms “belt” and “chain” are considered synonyms and are used interchangeably within the description.

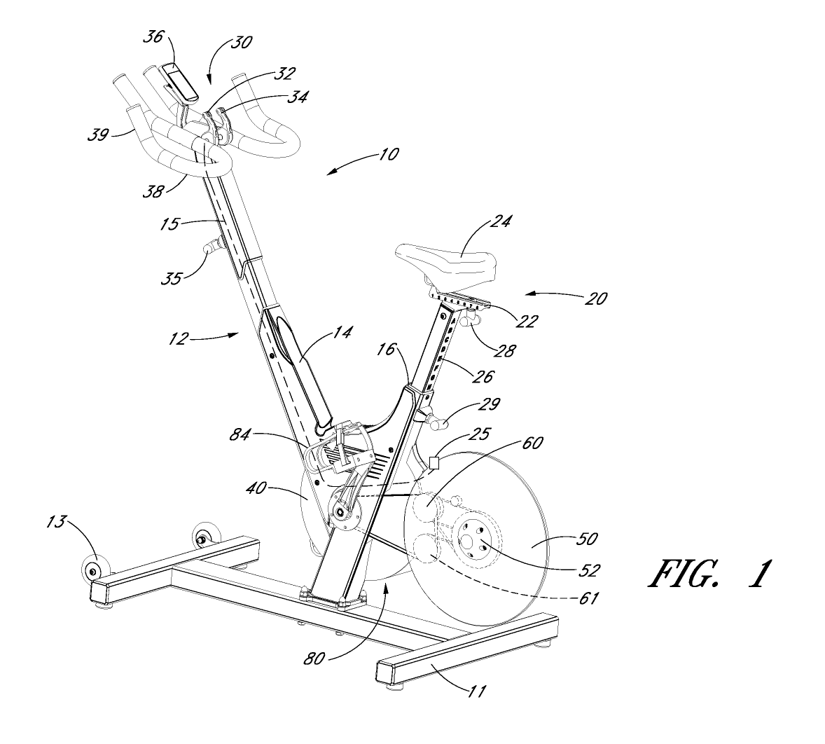

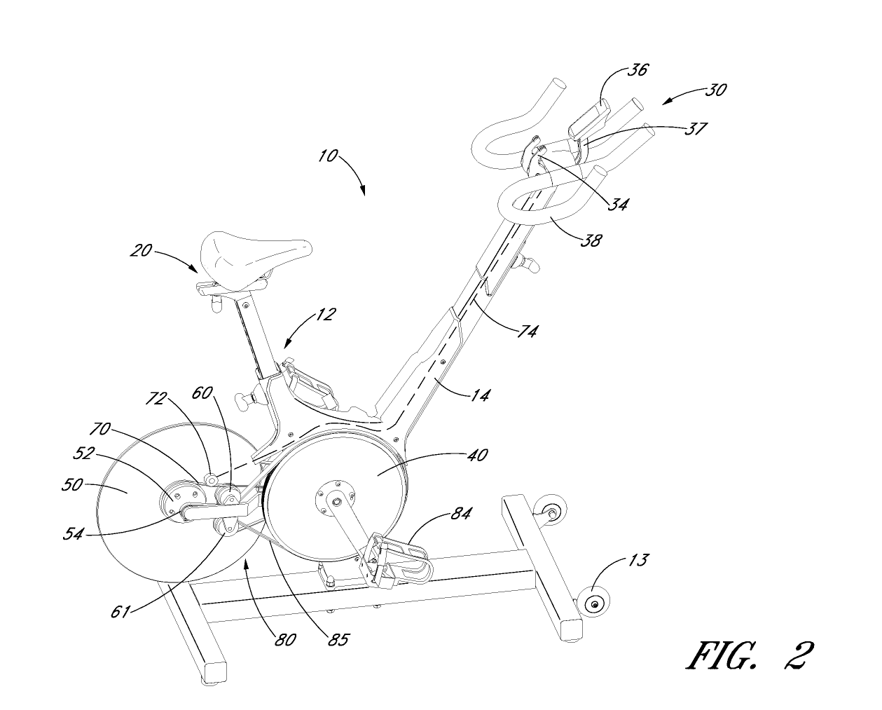

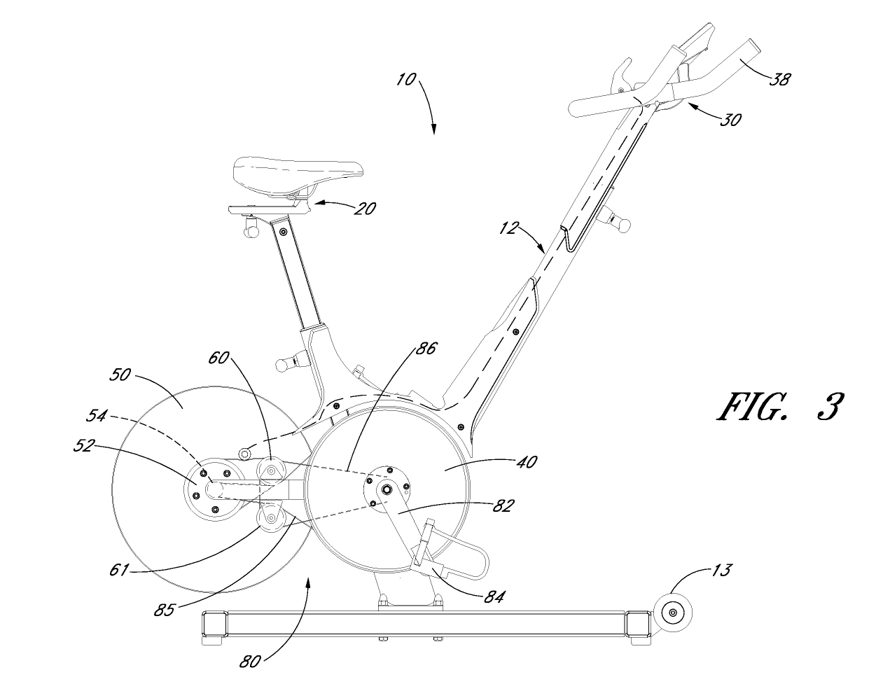

FIGS. 1 and 2 illustrate a left and right perspective view, respectively, of an exercise apparatus 10 in accordance with one embodiment of the present invention. FIG. 3 illustrates a right side view of the exercise apparatus 10 of FIG. 1. The exercise apparatus 10 comprises a stationary exercise bicycle configured to generate reciprocating motion when in use. Such reciprocating motion provides users with a vibratory exercise experience. In certain embodiments the exercise apparatus 10 is further configured to provide the option to simulate the cycling motion of a traditional bicycle.

In the embodiment depicted in FIG. 1, the apparatus 10 comprises a frame 12 supporting a drive train 80. A lower portion 11 of the frame 12 rests on a floor. One end of the lower portion 11 has casters 13 configured to facilitate movement of the apparatus from one location on the floor to another, when the apparatus is not in use. The frame 12 is generally v-shaped and supports a seat assembly 20 and a handlebar assembly 30 at the back and front distal ends, respectively, of the v-shaped frame 12. The frame 12 further supports a driving wheel 40, a flywheel 50, and at least one idler 60, 61. A frame housing 14 may conceal some components of the apparatus 10 to create a more integrated-looking design and improve safety.

The seat assembly 20 comprises a seat post 22 and a seat 24. The seat post 22 extends rearward from the seat 24 and is fitted into an elevating rod 26. The upper end of the elevating rod 26 receives the seat post 22. A fastener 28 fixes a position of the seat post 22 relative to the elevating rod 26. A user may loosen the fastener 28, adjust the forward-aft position of the seat 24, and retighten the fastener 28 to thereby fix the forward-aft position of the seat 24 in a desired position.

The lower end of the elevating rod 26 passes through a tube 16 secured to the frame 12. The elevating rod 26 may have a plurality of holes formed therein. The holes are selectably engageable with a vertical seat fastener 29. The seat fastener 29 may include a spring-loaded pin which is inserted in the selected hole. The fastener 29 can be temporarily disengaged from one of the holes and the seat 24 can be raised or lowered to change the distance between the pedals 84 and the seat 24 to adapt the position of the seat 24 to the physical characteristics of a particular user. The spring-loaded fastener 29 may re-engaged the most closely aligned one of the holes to restrain the elevating rod 26 at the selected height. Alternatively, the vertical seat fastener 29 may compress the elevating rod 26 within the tube 16 so as to fix the vertical position of the seat 24. In such an embodiment, the elevating rod need not have holes formed therein to receive the vertical seat fastener 29.

The seat 24 is adjustable in a generally vertical direction to accommodate variations in the physical characteristics of users. The seat 24 may also be tilted so as to rotate about the elevating rod 26 independent from the generally vertical adjustments to change the angle of the seating surface on the seat 24.

A handlebar assembly 30 is mounted at the upper front end or neck portion of the v-shaped frame 12 and comprises a gear shift 32, a clutch control 34, a display device 36, and handlebars 38. The handlebars 38 may comprise a racing-type handlebar which includes an upper handlebar grip portion connected with a lower handlebar grip portion via a forwardly and downwardly extending curved member, an aero-type handlebar which has two parallel, forward extending hand grips spaced narrowly apart and located at a relatively high position, or a combination thereof or the like. Alternatively, the handlebars 38 may have a mountain bike configuration comprising a horizontal bar extending to the right and left sides of the cycle frame. The example provided in FIG. 1 includes features of an aero-type handlebar. A left and a right handgrip 39 each extends generally along a longitudinal axis of the apparatus 10 and includes a 180 degree bend to form a general u-shape in each handlebar 38. The u-shape portion provides a resting surface perpendicular to the forearms of the user. Because at least portions of the handgrips 39 extend in a forward direction, a user may lean forward to a greater extent, thus simulating a racing stance with a reduced frontal surface area.

Each handgrip 39 has a length sufficient to accommodate the width of a user's hand and to further accommodate variations in the position of a user's hand Preferably, each handgrip 39 is cylindrical and has a respective gripping surface mounted thereon to assist a user in grasping the handgrips. The gripping surfaces may advantageously be padded for the comfort of the user's hands The handlebars 38 may provide a user multiple positions for their hands A vertical handlebar fastener 35 fixes the height of the handlebar assembly 30 relative to the frame 12.

As illustrated in FIG. 1, The gear shift 32 of the handlebar assembly 30 is fixedly attached to an end of a gear cable 15. The gear cable 15 is routed inside the upper front end or neck portion of the frame 12. The gear cable 15 continues downward to a location within the frame housing 14 near the intersection of the neck portion and the seat portion of the frame 12. Preferably at that location, the gear cable 15 is coiled in a counter-clockwise direction and then continues rearward to a resistance assembly 25. An exemplary eddy current braking system that can be employed in the apparatus 10 is disclosed in U.S. patent application Ser. No. 11/584,283, which is incorporated by reference in its entirety. In other embodiments of the cycle, other known braking mechanisms, such as brake pads, may be used. In still other embodiments, the stationary exercise cycle may not include a braking system. By coiling or keeping slack in the gear cable 15 at a location between the gear shift 32 and the resistance assembly 25, the height of the gear shift 32 together with the handlebar assembly 30 may be adjusted by a user. Advantageously, the accessibility of the gear shift 32 to a user is maintained even when the handlebar assembly 30 is adjusted upwards or downwards. A user is further able to pivot the gear shift 32 about a lever portion to actuate the gear cable 15 and thereby change resistance levels.

As illustrated in FIG. 2, the clutch control 34 of the handlebar assembly 30 is fixedly attached to an end of a clutch cable 74. The other end of the clutch cable 74 attaches to a clutch bearing 72. The clutch cable 74 is routed inside the upper front end or neck portion of the frame 12 and continues downward to a location within the frame housing 14. The clutch control 34 allows a user to select between an unengaged and an engaged state. When the clutch control 34 is set to the unengaged state, the clutch bearing 72 is not sufficiently engaged with clutch belt 70 to cause the eccentric or vibratory operation of the cycle. In such a state, the cycle 10 is configured to simulate the smooth pedaling experience of a conventional stationary exercise bicycle. When the clutch control 34 is set to the engaged state setting, the clutch bearing 72 sufficiently engages the clutch belt 70 to cause the eccentric or vibratory operation of the cycle. In such a state, the vibration of the cycle provides users with a vibratory exercise experience. The feature of allowing a user to switch between engaged and unengaged states is not necessary to practice the invention. In certain embodiments, the cycle is configured to continually operate in the eccentric or vibratory mode or to automatically switch between the two modes. This automatic switching can coincide with the user changing the resistance of the cycle or a predetermined exercise profile. A more detailed description of the clutch engagement and the vibratory mechanism is provided below.

In some embodiments, the clutch control 34 can be flipped, pivoted, or rotated so as to transition the apparatus 10 between the unengaged and engaged states. In such embodiments, the physical movement of the clutch control 34 moves the clutch cable 74, thereby causing a lever arm 76 to pivot, which further causes the clutch bearing 72 to move relative to the clutch belt 70. In other embodiments, a user selects the engaged or unengaged state using an electronic interface, thereby sending a wired or wireless message to a lever arm, which moves the clutch bearing relative to the clutch belt. Regardless of the mechanism, by using the clutch control 34, a user can select to turn the cycle's vibratory effect on or off before or during exercise.

In some embodiments, such as the embodiment depicted in FIGS. 1 and 2, the apparatus 10 further includes a display device 36 supported on a riser 37 or built into the handlebar apparatus. The display device 36 is positioned in front of a user seated on the seat assembly 20. The display device 36 houses a processor or CPU and stores software for determining the values of operational parameters displayed on the device 36. In certain embodiments, the display device 36 is optionally capable of communicating, wired or wirelessly, with an external computer system via a communications cable and an adapter unit. The display device 36 may be configured to display the relative resistance currently selected by the user. The gear may be selected by a user by selectively rotating the gear shift 32 in an upward direction to increase the resistance force created by the resistance assembly 25 and selectively rotating the gear shift 32 in a downward direction to decrease the resistance. In alternative embodiments, the gear may be selected automatically or by a user using an alternative gear selection mechanism. In alternative embodiments of the apparatus 10 in which a gear shift 32 is not used, controls for increasing and decreasing the resistance may be implemented into the handlebar assembly 30.

The display device 36 may also calculate and display data such as current speed, average speed, current rotations per minute (RPM), average RPM, distance traveled, estimated calories burned, length of time the cycle has been in use, power expended by a user, and/or heart rate. A sensor may be integrated into the handlebars 38 to sense the heart rate. In some embodiments, the display device 36 may additionally display simulated cycling routes or elevation profiles. Automatic switching of the vibratory effect off and on can be timed to changes in such routes or elevation profiles.

As illustrated in FIG. 3, the drive system 80 of the apparatus 10 comprises a driving wheel 40, a flywheel 50, a belt 85, and one or more idlers 60, 61. The drive system 80 is generally located at or near the proximal end of the v-shaped frame 12 at a suitable position between the handlebar assembly 30 and the seat assembly 20.

When in use, a user seated in the seat assembly 20 is able to grip the handlebars 38 while the user's feet engage two pedals 84 and apply forces to the driving wheel 40 via two crank arms 82, 83. Each crank arm 82, 83 is removably or fixedly attached at one end to the pedal 84. Each pedal 84 is configured to rotate about a longitudinal axis at the connection with the respective crank arm 82, 83. The other end of each crank arm 82, 83 is attached directly or indirectly to the driving wheel 40 such that the two crank arms 82, 83 are located on opposite sides of the driving wheel 40. The pedals 84 may be toe-clip style pedals, clipless style pedals, or flat pedals with an accompanying adjustable strap. When in use, a user applies force onto the two pedals 84, thereby turning the crank arms 82, 83, and driving the driving wheel 40 to rotate.

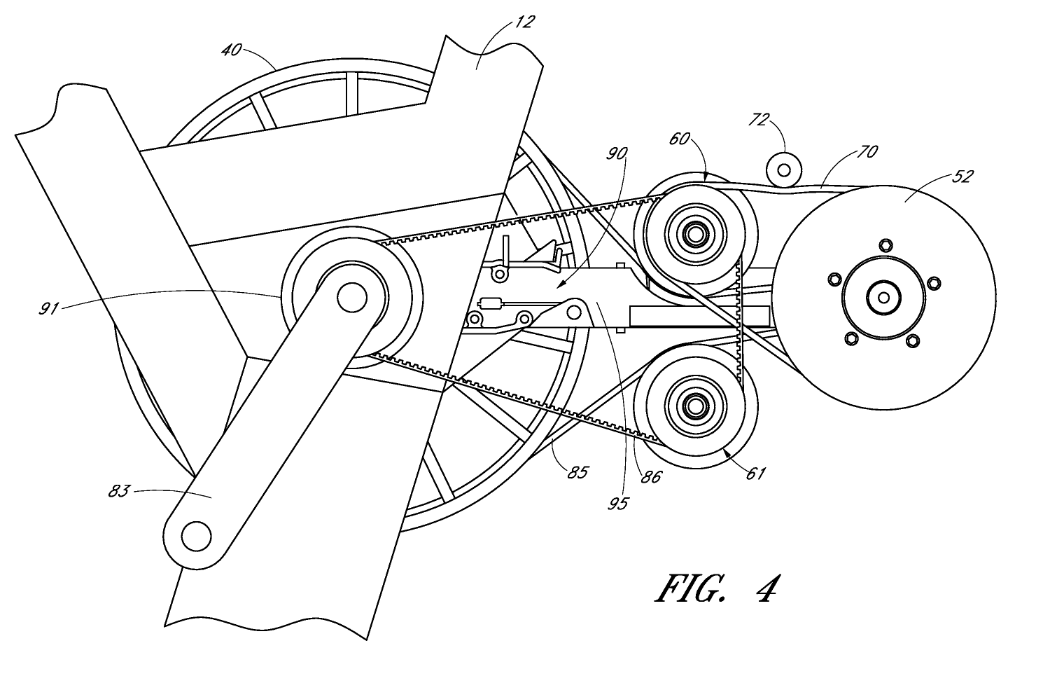

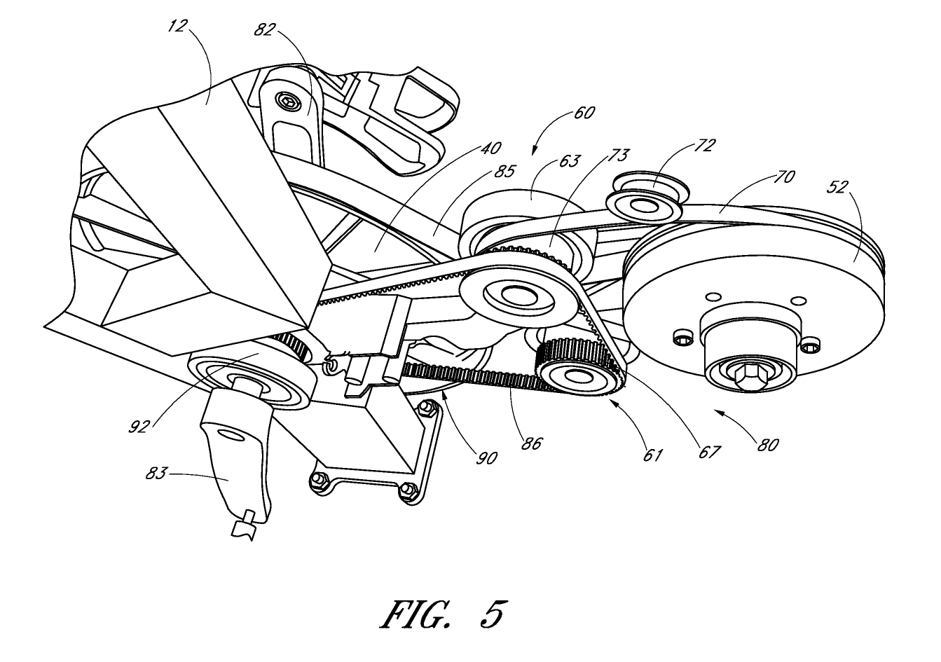

In the embodiment depicted in FIGS. 4 and 5, the belt 85 wraps around a substantial portion of the outer circumference of the driving wheel 40 and around a substantial portion of the circumference of a flywheel pulley 54 positioned about the central axis of the flywheel 50. The flywheel pulley 54 has a smaller diameter than the flywheel 50 and is preferably integral with the flywheel 50 such that rotation of the flywheel pulley 54 rotates the flywheel 50. The position of the belt 85 relative to the flywheel pulley 54 and the driving wheel 40 couples the rotation of the flywheel 50 with the rotation of the driving wheel 40. Accordingly, force applied to the crank arms 82, 83, which drives the driving wheel 40, causes the flywheel 50 to rotate. The relative sizes of the driving wheel 40 and the flywheel pulley 54 are such as to achieve a step up of speed. In other words, while coupled, the flywheel 50 rotates faster than the driving wheel 40.

The flywheel pulley 54 may be a multi-groove pulley configured to receive a grooved belt 85. The belt 85 is preferably grooved and comprises an elastic material. For example, an elastic belt 85 known by the trade name Flexonic is available from Hutchinson Worldwide in France. Other materials for the belt 85 can be used, including inelastic materials. Further, the belt 85 need not be grooved, and both the belt 85 and the contact surface of the flywheel pulley 54 may be smooth.

The embodiment depicted in FIGS. 4 and 5 further comprises two idlers 60, 61. Other embodiments may only include a single idler, while others may include more than two idlers. In FIGS. 4 and 5 the flywheel 50 has been removed from the flywheel pulley 54. The idlers 60, 61 are positioned so as to contact at least a portion of the belt 85. In the illustrated embodiment, the idlers 60, 61 are located near the flywheel 50 and are positioned so as to pinch or narrow the space between a top portion of the belt 85 and a bottom portion of the belt 85. The illustrated positions of the idlers 60, 61 further force more of the belt 85 into contact with the flywheel pulley 54. The increased contact surface area increases friction between the belt 85 and the flywheel pulley 54 so as to inhibit the belt 85 from slipping relative to the flywheel pulley 54.

As illustrated in FIGS. 4 and 5, the driving wheel 40, flywheel 50, and idlers 60, 61 are coupled to the frame 12 through a bottom bracket assembly 90. The bottom bracket assembly 90 includes a bottom bracket shell 91 and extension 95. The bottom bracket shell 91 is fixedly connected to the cycle frame 12. In the illustrated embodiment, the bottom bracket shell 91 is positioned at or in close proximity to the proximal end of the v-shaped frame 12 where the two arms of the “v” converge.

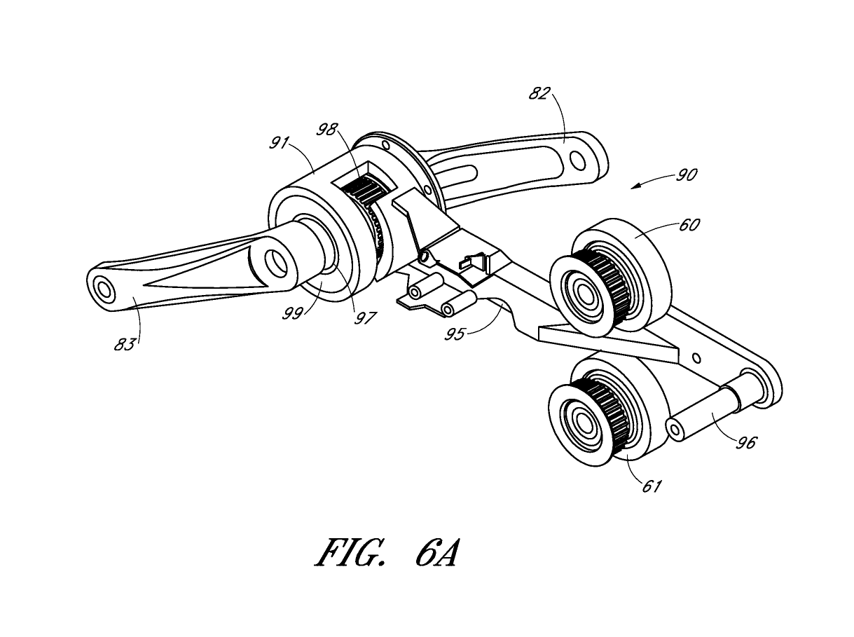

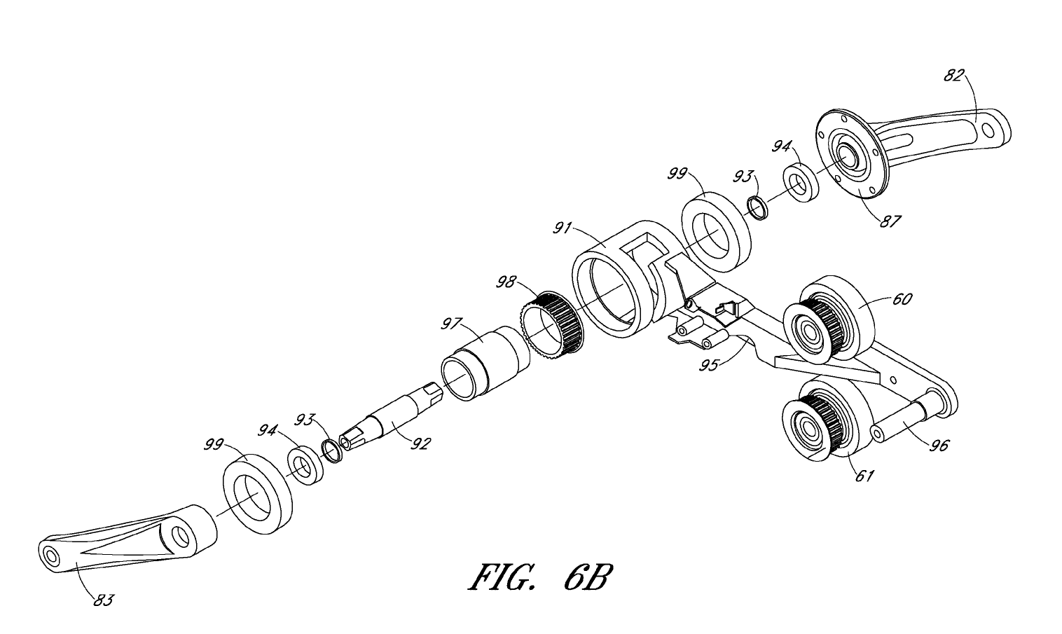

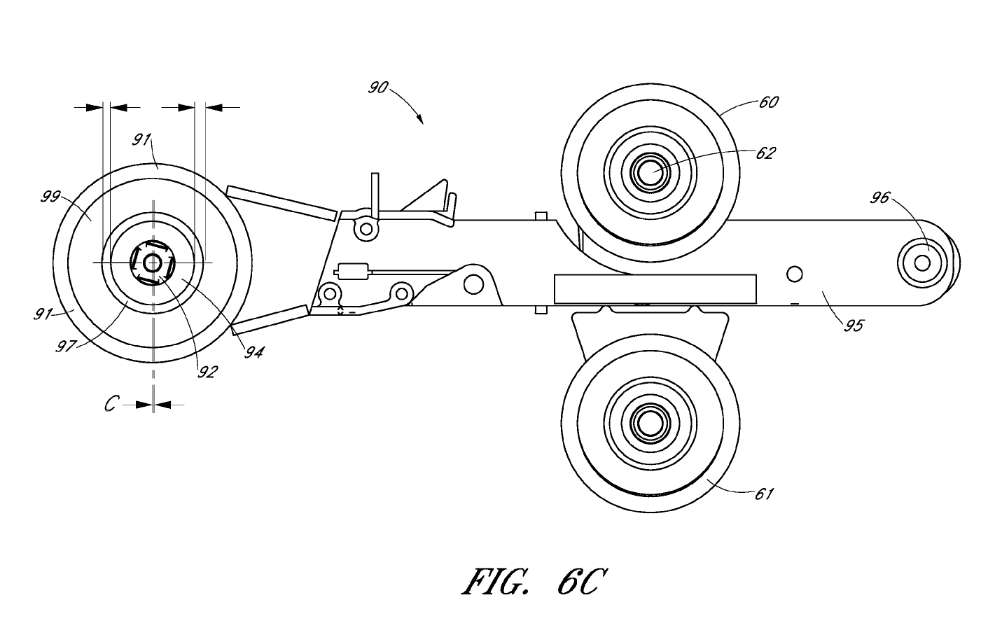

Detailed illustrations of an exemplary embodiment of the bottom bracket assembly 90 are depicted in FIGS. 6A through 6C. As shown in the exploded view of FIG. 6B, a bottom bracket axle 92, which rotates about its central longitudinal axis, is disposed within the bottom bracket shell 91 of the frame 12. A spacer 93 and an axle bearing 94 are disposed on each end of the bottom bracket axle 92 to enable and control rotation of the bottom bracket axle 92 relative to the bottom bracket shell 91. As explained below, when simulating smooth cycling the bottom bracket axle 92 rotates about its central longitudinal axis. The central longitudinal axis of the bottom bracket axle 92 is essentially stationary. In the vibratory mode, the bottom bracket axle 92 not only rotates about its central longitudinal axis but its central longitudinal axis also rotates eccentrically within the bottom bracket shell 91. The central longitudinal axis of the bottom bracket axle 92 is no longer stationary.

The crank arms 82, 83 attach to opposite ends of the bottom bracket axle 90. In the depicted embodiment, the face 87 of the right crank arm 82 has a flat circular surface area and a greater diameter than the face of the left crank arm 83. The face 87 includes a plurality of holes configured to receive bolts, screws, or other fixation devices. Complementary holes are disposed on the surface of the driving wheel 40. Fixation devices are tightened within the holes to secure the driving wheel 40 to the right crank arm 82. Each crank arm 82, 83 is secured against a face of the axle bearing 94 so as to rotate with the bottom bracket axle 92. With such a configuration, when sufficient force is applied to the pedals 84 to turn the crank arms 82, 83, both the bottom bracket axle 92 and the attached driving wheel 40 rotate in response.

As illustrated in FIGS. 6A through 6C, the extension 95 of the bottom bracket assembly 90 extends in a rearward direction from the bottom bracket shell 91 of the frame 12. A flywheel axle 96 is positioned at the backend of the extension 95 and is configured to receive the flywheel hub 52. The flywheel 50 is mounted to the flywheel hub 52. As a result, the flywheel 50 is mounted on the flywheel axle 96 at a rear section of the frame 12 in linear alignment with the driving wheel 40.

The bottom bracket assembly 90 further comprises two idler axles 62 positioned above and below the extension 95, respectively. Each idler axle 62 is configured to receive an idler 60, 61. In the illustrated embodiments, the two idlers 60, 61 are in vertical linear alignment relative to each other. Of course in embodiments that include more than one idler, the idlers may be arranged in a multitude of different ways relative to one another in addition to the illustrated arrangement.

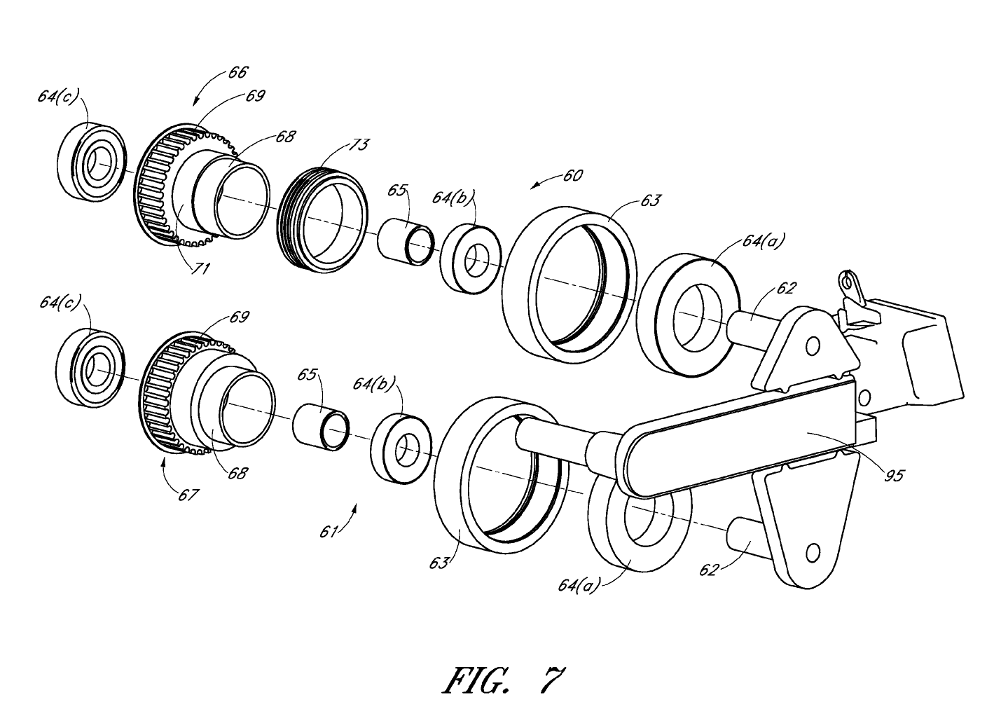

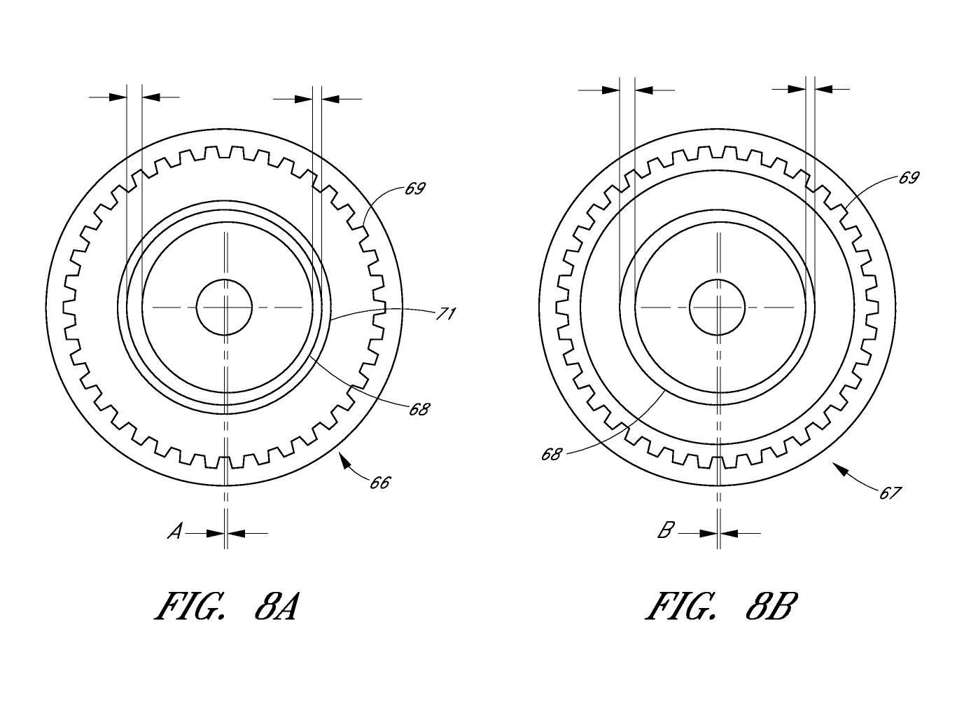

An exploded view of one embodiment of the idlers 60, 61 is provided in FIG. 7. FIGS. 8A and 8B are side views of the eccentric pulleys 66, 67 from FIG. 7. Each of the idlers 60, 61 comprises an eccentric pulley 66, 67, one or more bearings 64, an outer ring 63, and one or more spacers 65. A portion of the outer circumference of each eccentric pulley 66, 67 can include a toothed or grooved region 69 in order to engage a grooved or toothed timing belt 86. The toothed regions 69 preferably have central axes which are coaxial with the axles 62 so that the toothed regions 69 rotate concentrically about the axles 62. Another region 68 of the outer circumference of each eccentric pulley 66, 67 is configured to eccentrically rotate relative to the axles 62. In this way, the central axes of the outside diameters in eccentric regions 68 are configured to eccentrically rotate relative to the axles 62.

In the illustrated embodiment, the outer rings 63 are positioned in the eccentric regions 68 of the eccentric pulleys 66, 67. A bearing 64(a) is disposed between the inside diameter of each outer ring 63 and the outside diameter of each of the eccentric pulley 66, 67 to allow the outer rings 63 to rotate relative to the eccentric pulleys 66, 67. The outer rings 63 have a circular shape. The central axes of the outer rings 63 are stationary with respect to the axles 62 when the eccentric pulleys 66, 67 are not rotating. In this way, the outer rings 63 and the bearings 64(a) are decoupled from the eccentric pulleys 66, 67 and are free to rotate with respect to the eccentric pulleys 66, 67. However, when the eccentric pulleys 66, 67 are rotating, the outer rings 63 will then also rotate eccentrically with respect to the axles 62. In this way, the central axes of the outer rings 63 move with respect to the axles 62 when the eccentric pulleys 66, 67 are rotating.

As shown most clearly in FIGS. 8A and 8B, the centers of the inside and outside diameters of the eccentric pulleys 66, 67 are offset a distance A, B from each other, respectively. In this way, the tubular wall thicknesses of the eccentric pulleys 66, 67 vary around their circumferences. When the eccentric pulleys 66, 67 rotate, their asymmetrical tubular wall causes the central axes of the outer rings 63 to move causing lopsided, or eccentric, revolutions. When the eccentric pulleys 66, 67 are not rotating, the central axes around which the outer rings 63 rotate are stationary. In this way the user experiences the smooth pedaling of a conventional stationary exercise bicycle.

The idler 60 further includes a clutch pulley 73 for selectively engaging with the flywheel 50 via the clutch belt 70. The clutch pulley 73 is disposed on the outer circumference of the eccentric pulley 66 in region 71. The clutch pulley 73 is secured relative to the eccentric pulley 66 so as to only rotate with the eccentric pulley 66. Rotation of the clutch pulley 73 via the clutch belt 70 directly drives rotation of the eccentric pulley 66.

Bearings 64(b), (c) are disposed between the inside diameters of the eccentric pulleys 66, 67 and the outside diameter of the axles 62 to allow the idlers 60, 61 to rotate relative to the axles 62.

Returning to FIGS. 6B and 6C, the bottom bracket assembly 90 also comprises a tubular eccentric sleeve 97 with an inner diameter defining the walls of a passage. The passage is adapted to receive the bottom bracket axle 92. The eccentric sleeve 97 does not securely engage the bottom bracket axle 92, but rather allows for rotation of the bottom bracket axle 92 within the eccentric sleeve 97. An outer diameter of the eccentric sleeve 97 is adapted for insertion into the inner diameters of a timing belt pulley 98 and a plurality of sleeve bearings 99. In the illustrated embodiment, two sleeve bearings 99 are positioned on opposite ends of the eccentric sleeve 97 with the timing belt pulley 98 positioned around the eccentric sleeve 97 between the two sleeve bearings 99. The sleeve bearings 99 are further positioned between the eccentric sleeve 97 and the bottom bracket shell 91. The sleeve bearings 99 permit rotational movement of the eccentric sleeve 97 within the bottom bracket shell 91.

In the illustrated embodiment of FIG. 6C, the center of the inside diameter of the eccentric sleeve 97 is illustrated as being offset a distance from the center of an outside diameter of the eccentric sleeve 97. In this way, the tubular wall thickness of the eccentric sleeve 97 varies around its circumference. In one embodiment, the maximum offset distance C is 0.030 inch. Those of skill in the art will appreciate that the offset distance can be made smaller or larger without straying from the spirit of the invention. When the eccentric sleeve 97 rotates, its asymmetrical tubular wall causes the longitudinal axis of the bottom bracket axle 92 to move causing lopsided, or eccentric, revolutions. When the eccentric sleeve 97 is not rotating, the longitudinal axis around which the bottom bracket axle 92 rotates is stationary. In this way the user experiences the smooth pedaling of a conventional stationary exercise bicycle.

As illustrated in FIG. 6A, the bottom bracket shell 91 includes an opening configured for the timing belt 86 to wrap about the timing belt pulley 98. The timing belt 86 exits the bottom bracket shell 91 and then wraps around the toothed regions 69 on each eccentric pulley 66, 67 of each idler 60, 61. When the timing belt 91 is in contact with the timing belt pulley 98 and the two eccentric pulleys 66, 67, the loop formed by the timing belt has a generally triangular configuration. The timing belt 86 drives the eccentric pulleys 66, 67 and the timing belt pulley 98.

A third belt, the clutch belt 70, is most clearly illustrated in FIGS. 4 and 5. The clutch belt 70 wraps around a portion of the outer circumference of the flywheel hub 52 and around at least one idler. In the illustrated examples, the clutch belt 70 is in contact with the flywheel hub 52 and region 71 of the eccentric pulley 66 of idler 60.

When the cycle is in an unengaged state, the clutch bearing 72 located above and in proximity to the clutch belt 70 does not sufficiently press against the clutch belt 70 to cause the flywheel hub 52 to drive the eccentric pulley 66. Accordingly, flywheel rotation is not transferred to the eccentric pulley 66. Thus, in the unengaged state, the eccentric pulley 66 does not rotate. The timing belt 86 is driven by the eccentric pulley 66. Therefore, when the eccentric pulley 66 does not rotate, the timing belt 86 does not rotate, and consequently, neither the eccentric pulley 67 nor the eccentric sleeve 97 rotates. Consequently, in the unengaged state, there is no eccentric rotation within the cycle 10, and users experience a smooth, conventional cycling experience.

When the cycle 10 is transitioned into an engaged state, the clutch bearing 72 pivots so as to bear down on the clutch belt 70. In such a position, the clutch bearing 72 generates sufficient tension in the clutch belt 70 to cause the flywheel hub 52 to drive the eccentric pulley 66. The eccentric pulley 66 is thereby coupled to the flywheel hub 52. As a result, rotation of the flywheel hub 52 generates rotation in the clutch pulley 73. Since the clutch pulley 73 and the eccentric pulley 66 are coupled, the eccentric pulley 66 also rotates. Rotation of the eccentric pulley 66 drives the timing belt 86, which drives rotation of the timing belt pulley 98 and the eccentric pulley 67. When the timing belt pulley 98 rotates, the eccentric sleeve 97 rotates causing the central longitudinal axis of the bottom bracket axle 92 to rotate eccentrically with respect to the central axis of the bottom bracket shell 91. This eccentric rotation of the eccentric sleeve 97, in conjunction with the eccentric rotation of the eccentric pulleys 66, 67 of the idlers 60, 61, imparts uneven, reciprocating motion into the revolutions of the cycle components without causing localized stretching or increased tension on the belt or chain 85. Such reciprocating motion generates vibrations felt in the pedals 84 and throughout the frame 12. As a result, individuals using the cycle 10 in the engaged state experience whole body vibrations during exercise.

The cycle of the present invention is configured to generate a desirable vibratory exercise experience. However, without the idlers 60, 61, the uneven reciprocating motion experienced within the drive system 80 would cause periodic sagging and areas of slack in the belt 85. Such sagging and slack in the belt 85 could result in undesirable fluctuations in the rotational speed of the flywheel 50 or even slippage of the belt 85 against the flywheel 50. These unintended bursts of acceleration and deceleration would lead to unpredictable pedal strokes. Such pedal strokes are undesirable and should be avoided.

With a plurality of idlers 60, 61 positioned above and below the belt 85, the adverse effects of the vibrations on the belt 85 during pedal strokes can be largely avoided. As described previously, in the illustrated embodiments, the axes of the driving wheel 40 and flywheel 50 are spaced apart along a line. A first portion of the belt 85, having a first length, is disposed in a region above the line, and a second portion of the belt 85, having a second length, is disposed in a region below the line. One idler 60 is positioned above the line and the second idler 61 is positioned below the line. Each idler 60, 61 is in contact with the belt 85 and generates additional tension in the belt 85. With the additional tension present, the first length of the belt and the second length of the belt each stay generally constant, effectively eliminating the undesirable sagging of the belt.

The invention may be embodied in other specific forms without departing from its spirit or essential characteristics. The described embodiments are to be considered in all respects only as illustrative and not restrictive. The scope of the invention is therefore indicated by the appended claims rather than by the foregoing description. All changes which come within the meaning and range of equivalency of the claims are to be embraced within that scope.

1. A cycle comprising:
a frame;
an axle disposed in the frame and configured to eccentrically rotate relative to the frame;
a driving wheel coupled to the axle;
a flywheel coupled to the frame so as to rotate about an axis, the axis being spaced from the axle along a line;
a belt contacting the driving wheel and the flywheel, a first portion of the belt being disposed in a region above the line and having a length, and a second portion of the belt being disposed in a region below the line and having a length; and
an idler coupled to the frame and configured to rotate eccentrically, at least a portion of the idler contacting the belt so that the length of the belt in the first region and the length of the belt in the second region stay generally constant at least when the belt drives the flywheel.

2. The cycle of claim 1, wherein the driving wheel rotates eccentrically.

3. The cycle of claim 1, wherein the eccentric rotation of the axle imparts a vibration felt by a user of the cycle.

4. The cycle of claim 1, wherein the eccentric rotation of the axle is selectable by the user.

5. The cycle of claim 1, wherein the frame comprises a bottom bracket having a central axis, and wherein the axle rotates about an axis that is offset from the central axis.

6. The cycle of claim 1, wherein a position of a rotational axis of the axle relative to the frame changes as the axle rotates.

7. The cycle of claim 5 further comprising an eccentric sleeve disposed between the bottom bracket and the axle.

8. The cycle of claim 7 further comprising a bearing disposed between the eccentric sleeve and the bottom bracket.

9. The cycle of claim 7, wherein a center of the inside diameter of the eccentric sleeve is offset a distance from a center of the outside diameter of the eccentric sleeve.

10. (canceled)

11. (canceled)

12. The cycle of claim 1 further comprising a second axle, the idler rotating about the second axle, wherein the portion of the idler contacting the belt rotates eccentrically relative to the axle.

13. The cycle of claim 1, wherein the idler has an eccentric outer circumference, and wherein at least a portion of the belt contacts the eccentric outer circumference.

14. (canceled)

15. (canceled)

16. (canceled)

17. The cycle of claim 1, wherein the axle is configured to receive one or more crank arms.

18. (canceled)

19. The cycle of claim 1, wherein the belt contacts a portion of an outer circumference of the driving wheel, and wherein a distance between a contact point of the belt with the driving wheel at a fixed angular location and a rotational axis of the driving wheel changes as the axle is rotated.

20. The cycle of claim 1, wherein the idler is configured to be driven by the flywheel.

21. (canceled)

22. (canceled)

23. (canceled)

24. (canceled)

25. (canceled)

26. (canceled)

27. (canceled)

28. (canceled)

29. (canceled)

30. (canceled)

31. (canceled)

32. A cycle comprising:
a frame;
a driving wheel configured to be rotated eccentrically by a user so as impart a vibration felt by the user;
a flywheel coupled to the frame;
a belt contacting the driving wheel and the flywheel; and
at least one idler fixed relative to the frame so as to rotate eccentrically, at least a portion of the idler contacting the belt.

33. (canceled)

34. The cycle of claim 32 further comprising an axle coupled to the driving wheel; wherein the frame comprises a bottom bracket having a central axis, and wherein the axle rotates about an axis that is offset from the central axis.

35. (canceled)

36. (canceled)

37. (canceled)

38. (canceled)

39. (canceled)

40. (canceled)

41. (canceled)

42. (canceled)

43. (canceled)

44. (canceled)

45. (canceled)

46. (canceled)

47. (canceled)

48. (canceled)

49. (canceled)

50. (canceled)

51. (canceled)

52. (canceled)

53. (canceled)

54. (canceled)

55. (canceled)

56. (canceled)

57. (canceled)

58. A drive system comprising:
a rotational member configured for eccentric rotation;
a belt configured to rotate with the rotational member; and
at least one idler contacting the belt and configured to rotate eccentrically so as to maintain a generally constant length of the belt.

59. The drive system of claim 58 further comprising another idler having an eccentric outer circumference, at least a portion of the eccentric outer circumference contacting the belt.

60. The drive system of claim 59, wherein the idlers contact portions of the belt above and below the line.

61. The drive system of claim 59, wherein one idler is configured to be driven by the other idler.

62. (canceled)
